(19) United States
(12) Patent Application Publication
(10) Pub. No.: US 2003/0154924 A1
(43) Pub. Date: Aug. 21, 2003

(54) Automatic milking

(76) Inventors: Uzi Birk, Huddinje (SE); Hans Martin Sjolund, Stockholm (SE)

Correspondence Address: STINSON MORRISON HECKER LLP, ATTN: PATENT GROUP, 1201 WALNUT STREET, SUITE 2800, KANSAS CITY, MO, 64106-2150, US

(21) Appl. No.: 10/240,329

(22) PCT Filed: Mar. 12, 2001
(86) PCT No.: PCT/EP01/02782

(30) Foreign Application Priority Data
Mar. 31, 2000 (EP) 00302752.1

(51) Int. Cl. A01J 3/00; A01J 5/00

(52) U.S. Cl. 119/14.02

(57) ABSTRACT

For sensing presence of foremilk, in the separation of foremilk or for detecting incorrect premilking, the transparency of the milk to transmission of light therethrough is sensed by a sensor (4), and a control unit (12) which receives signals from the sensor operates a valve (7) so that foremilk is diverted to a waste container (10) whereas good quality milk passes to a storage container (3). The inverted peak in the transparency curve which is indicative of foremilk is detected and the control unit actuates the valve (7) to minimise loss of good quality milk with the foremilk.

This invention relates to the milking of animals and it is particularly concerned with the separation of foremilk in an automatic milking process. It is well known that, in the case of milking cows, the milk initially extracted from the teat of an udder is generally of relatively poor quality due to contamination by comparatively high levels of bacteria and/or dirt, this initial milk flow being commonly called the premilk or foremilk. So that the overall quality, and hence the value of the milk obtained from a cow is not impaired by the foremilk it has become normal practice for the foremilk to be separated and discarded. In the past this was effected by the parlour worker directing a few squirts of milk from each teat either onto the floor of the milking parlour or into a cup before fitting the teat cups of the milking machine onto the teats of the animal. In recent years automatic milking machines have been developed which are capable of applying the teat cups to the teats without requiring any human intervention, and alternative ways of separating the foremilk suitable for use with such automatic machines have been proposed.

In U.S. Pat. No. 4,190,020 there is described a valve device which is connected in a main milk line leading to a bulk storage tank and has a second outlet connected to a branch line leading to a bypass tank. A control unit connected to the valve device incorporates a timer which controls the valve device so that the milk flow for a predetermined time period from the start of milking is diverted into the branch line and hence to the bypass tank. The valve device also includes a sensor for sensing the milk colour with the intention of detecting milk contaminated by blood or pus, but this becomes effective only after the predetermined time for separation of the foremilk has elapsed. With such an arrangement, the amount of foremilk separated and discarded is substantially constant for all animals and this amount needs to be chosen to ensure that all the low quality foremilk will be separated in all cases. As a consequence some good quality milk will inevitably be lost with the separated foremilk.

The same disadvantage is suffered by the arrangements described in U.S. Pat. No. 5,865,138 and WO 99/31966. The former discloses use of three-way valve controlled by a timing circuit and/or a flow sensor for separation of foremilk, whereas the latter employs a mechanical arrangement which is operated by collection of predetermined amount of milk in a cup.

The present invention aims to provide a method and an apparatus which can reduce the wastage of good quality milk when separating the foremilk while still ensuring effective separation of all the foremilk.

This objective is achieved by a method of separating foremilk in an automatic milking process, characterised by controlling a means operable to divert foremilk away from a milk line in accordance with a sensed optical property of the milk whereby the amount of foremilk separated is dependent upon the sensed optical property.

More particularly the invention resides in a method of milking an animal wherein milk extracted from a teat of an animal is directed along a milk path to a container, an initial portion of the milk extracted from the teat being diverted from the milk path, characterised in that an optical property of the milk extracted from the teat is sensed and the diversion of the initial milk flow from the milk path leading to the container is controlled in dependence upon the optical property sensed.

The optical property of the milk which is sensed is preferably the transparency of the milk to electromagnetic radiation, more especially the transparency of the milk to transmission of light therethrough. It has been observed that the transparency initially falls rapidly as milk flow commences and then it rises again after an initial peak in the opacity of the milk which coincides with the flow of foremilk. Thus, by terminating the separation of foremilk when the rise in transparency is detected, it can be ensured that all the foremilk of unacceptable quality is separated without good quality milk being lost in the process.

The present invention also provides an apparatus for the automatic milking of animals comprising a teat cup connected to a main milk line through which milk extracted from a teat is conveyed, a device for directing milk to flow through the main milk line or to a branch line, control means for controlling the device so that an initial amount of milk extracted from a teat is directed into the branch line, and an optical sensing means for sensing an optical property of the milk upstream of the flow directing device, characterised in that the control means is responsive to a signal from the sensing means and operates the flow directing device to terminate flow of milk into the branch line and to direct the milk to flow through the main milk line when a predetermined change in the sensed optical property occurs.

The sensing means conveniently takes the form of a device for sensing the transparency of the milk, in particular its transparency to transmission of light, and this device suitably has a light source, such as a light omitting diode and a photosensitive component, e.g. a phototransistor, located on opposite sides of the milk flow path through the sensing device.

The control means is preferably programmed to operate the flow directing device so that the flow of milk into the branch line is terminated upon the milk transparency rising again following the initial fall at the commencement of the milk flow.

In connection with some automatic milking methods and systems it has been proposed to carry out premilking of the teats to extract the foremilk before attaching to the teats the teat cups employed during the subsequent main milking stage. A system of this kind is described in WO 99/27775. In such systems it would be of advantage to be able to detect if the premilking of a teat has not been correctly completed e.g. in order to prevent foremilk reaching and contaminating the milk collected in a bulk storage tank.

In accordance with another aspect therefore, the invention provides an automatic milking method in which premilking is performed to remove foremilk prior to a main milking stage, characterised in that the transparency of the milk is sensed at least during an initial period of the main milking stage and therefrom it is determined whether premilking was carried out correctly.

As will be understood from the description and explanations given above, incorrectly completed premilking can be detected by sensing a rise in the milk transparency occurring after an initial fall, which is indicative of a peak appearing in the opacity of the milk during a short period from the beginning of the milk flow due to the presence of foremilk. In response to incorrect premilking being detected, the main milking stage can be interrupted or a device, such as a three way valve, may be actuated to divert a first part of the milk flow during the main milking stage away from a milk line along which the milk is normally passed to a collection vessel during the main milking stage.

There is also provided in accordance with the invention an automatic milking apparatus, for performing the method of the further aspect, comprising means for premilking a teat from an udder, a teat cup for attachment to the teat after premilking for carrying out a main milking stage in which milk extracted by the teat cup is conducted through a milk line to a container, and a transparency sensing means for sensing the transparency of the milk extracted from the teat by the teat cup, characterised in that means are provided for interrupting delivery of milk to the container in response to the milk transparency sensed by the sensing means rising after an initial fall in transparency at the beginning of milk extraction during the main milking stage.

To assist a clear understanding of the invention it will now be described in greater detail with reference being made to the accompanying drawings, in which:

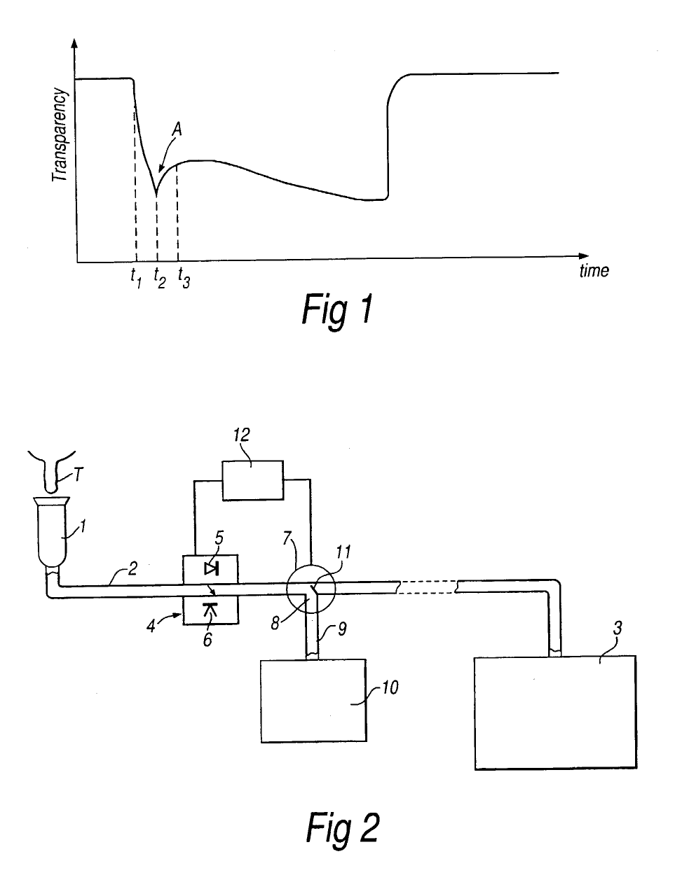

FIG. 1 is a graph showing the transparency of milk to transmission of light plotted against time in the course of milking one quarter of a cows's udder; and

FIG. 2 is a schematic illustration of an apparatus of an automatic milking machine in accordance with the invention.

The graph of FIG. 1 shows how milk transparency to light typically varies in the course of a complete milking of one quarter of the udder of a cow. The milk flow through the transparency sensor commences at time t₁ and as to be expected the transparency sensed immediately falls rapidly due to the influence of the milk entering the sensor. It has been observed that rather than flattening out at a lower level, the transparency curve then rises again initially quite steeply, which means the opacity of the milk reaches a peak at time t₂ as indicated in FIG. 1. The rate rise in transparency soon reduces after which the curve flattens out for a time before gradually falling as the milking proceeds. At the end of milking, the milk flow ceases and the transparency sensed by the sensor immediately returns essentially to the initial value at the beginning of the milking. The distinctive dip A in the transparency curve occurring within about 15 to 20 seconds from the start of milk flow is due to the foremilk. By detecting this dip and separating off the milk which flows up to time t₃, all the foremilk will be excluded from the milk which is collected for consumption without any good quality milk being lost as a consequence of being directed to waste with the foremilk.

FIG. 2 illustrates part of an automatic milking machine. The other parts which are not shown in the drawing form no part of the present invention and may be as generally known in the field of milking. Although only a single teat cup 1 is illustrated, it will be understood that four such teat cups will generally be provided in a machine for milking cows. The teat cup is connected to a milk tube 2 which constitutes a milk line for conveying milk to a collection vessel 3 such as a bulk storage tank. Of course, a milk meter for measuring the milk flow could be included in the milk line as could other known devices, such as sensors for detecting milk originating from a cow suffering from mastitis. At a short distance from the teat cup 1 the milk tube 2 is equipped with a milk transparency sensor 4. The sensor has a milk path therethrough with a light source 5, such as a light emitting diode disposed at one side of the milk path and a photosensitive component 6, such as a phototransistor, disposed at the other side of the flow path directly opposite the light source so that the sensor will produce a signal dependent on the light transmission across the flow path and hence the transparency of the milk passing along the flow path. Downstream of the sensor 4 and ideally very close thereto a three-way valve 7 is provided in the milk line, this valve having a branch outlet 8 to which one end of a tube is connected, the other end of the tube being connected to a container 10 for waste milk, or it could be directed to a drain. The valve 7 has a valve member 11 operable to interrupt flow through the milk line to the collection container 3, and to divert the milk instead through the branch outlet 8 into the tube 9 and hence to the waste container 10. A control unit 12 is connected to receive an output signal from the transparency sensor 4 and to emit a control signal for controlling the valve member 11 of the three way valve 7.

If the apparatus is to be used for separating foremilk, when the teat cup 1 is attached to the teat T the valve member 10 of the three way valve may be initially set for directing milk passing along the milk tube 2 from the teat cup to the waste container 10, or the control unit 12 may be programmed to set the valve member 11 in this position upon receiving from the transparency sensor 4 a signal indicating that milk flow has commenced, i.e, at time t₁ in FIG. 1. As milking proceeds the milk transparency sensed by the sensor 4 will follow the curve shown in FIG. 1. The control unit 12 determines when the dip or inverted peak A in the transparency curve has passed and a time t₃ will send a signal to the valve 7 to switch over the valve member 11 so that the subsequent milk flow will be directed along the main milk line to the storage container 3. Of course, the actuation of the valve 7 will be delayed slightly to take account of the milk in the milk line between the sensor 4 and the valve member 11.

The sensor 4, valve 7 and control unit 12 may also serve to detect milk affected by mastitis and direct such milk to the waste container 10. In the event of such milk being detected, e.g. a characteristically low milk transparency being sensed, the control unit will respond by maintaining the valve 7 adjusted to divert all the milk to the waste container 10. Of course, if preferred, alternative means could be provided for detecting milk affected by mastitis, e.g. a conductivity sensor, and/or for redirecting the milk flow so that this milk does not reach the storage container 3.

The apparatus of FIG. 2 may alternatively be used in a milking machine which is adapted to perform a preliminary premilking operation before the teat cup 1 is attached to the teat T for a subsequent main milking stage in order to detect if the premilking has not been properly completed with the consequence that foremilk is extracted from the teat during the main milking stage. In this case, when the teat cup is attached to the teat, since no foremilk is to be expected, the control unit 12 will be programmed to set the valve 7 so that the milk will be directed along the main milk line to the storage container 3. In the event that the inverted peak or dip characteristic A of the transparency curve is detected, thereby indicating the presence of foremilk, the control unit 12 will respond by actuating the valve 7 so that the valve member 11 opens the branch outlet 8 and the foremilk is diverted to the waste container 10. After a sufficient delay for all the foremilk to have flowed through the valve 7 the valve member 11 can be reset by the control unit to direct the flow to the storage container 10 for good milk. It will be appreciated that in this embodiment the valve 7 will need to be located so that the presence of foremilk can be detected and the valve operated, if necessary, before any foremilk can flow through the valve into the milk line leading to the container 3. Instead of operating the valve 7, the apparatus could be arranged to respond in some other way, such as by interrupting the main milking phase of the milking operation, if the presence of foremilk is unexpectedly detected by the transparency sensor 4 and the control unit 12.

Modifications are of course possible without departing from the scope of the invention. For example, the transparency sensor could be included in the structure of the teat cup as could the diverter valve 7.

1. A method of separating foremilk in an automatic milking process, characterised by controlling a means operable to divert foremilk away from a milk line in accordance with a sensed optical property of the milk whereby the amount of foremilk separated is dependent upon the sensed optical property.

2. A method according to claim 1, wherein the sensed optical property is the transparency of the milk to electromagnetic radiation.

3. A method according to claim 2, wherein the transparency of the milk is sensed by the transmission of light therethrough.

4. A method according to claim 2 or 3, wherein separation of the foremilk is terminated upon the sensed milk transparency rising after the milk opacity reaches an initial peak after the start of milking.

5. A method of milking an animal wherein milk extracted from a teat of an animal is directed along a milk path to a container, an initial portion of the milk extracted from the teat being diverted from the milk path, characterised in that an optical property of the milk extracted from the teat is sensed and the diversion of the initial milk flow from the milk path leading to the container is controlled in dependence upon the optical property sensed.

6. A method according to claim 5, wherein the optical property sensed is the transparency of the milk to electromagnetic radiation.

7. A method according to claim 6, wherein the transparency of the milk to transmission of light therethrough is sensed.

8. A method according to claim 6 or 7, wherein the diversion of milk from the milk path is terminated upon the milk transparency rising after reaching an initial peak in opacity after the start of milking.

9. An apparatus for the automatic milking of animals comprising a teat cup (1) connected to a main milk line (2) through which milk extracted from a teat is conveyed, a device (7) for directing milk to flow through the main milk line or to a branch line (8), control means (12) for controlling the device so that an initial amount of milk extracted from a teat is directed into the branch line (8), and an optical sensing means (4) for sensing an optical property of the milk upstream of the flow directing device (7), characterised in that the control means (12) is responsive to a signal from the sensing means (4) and operates the flow directing device (7) to terminate flow of milk into the branch line (8) and to direct the milk to flow through the main milk line when a predetermined change in the sensed optical property occurs.

10. An apparatus according to claim 9, wherein the sensing means comprises a device (4) for sensing the transparency of the milk.

11. An apparatus according to claim 10, wherein the sensing device (4) is adapted to sense the transparency of milk to transmission of light through the milk.

12. An apparatus according to claim 11, wherein the sensing device comprises a light source (5) and a photosensitive component (6) disposed on opposite sides of the milk flow path through the sensing device.

13. An apparatus according to claim 12, wherein the photosensitive component is a photo transistor (6) and/or the light source comprises a light emitting diode (5).

14. An apparatus according to any one of claims 10 to 13, wherein the control means (12) is arranged to operate the flow directing device (7) so that milk flow into the branch line (8) is terminated upon the milk transparency rising again following the initial fall at the commencement of milk flow.

15. An automatic milking method in which premilking is performed to remove foremilk prior to a main milking stage, characterised in that the transparency of the milk is sensed at least during an initial period of the main milking stage and therefrom it is determined whether premilking was carried out correctly.

16. A method according to claim 15, wherein the transparency of the milk is sensed by transmission of light therethrough.

17. A method according to claim 15 or 16, wherein in response to incorrect premilking being detected, the main milking stage is interrupted or a device is actuated to divert a first part of the milk flow during the main milking stage away from a milk line through which milk is passed to a collection vessel during the main milking stage.

18. A method according to claim 15, 16 or 17, wherein incorrectly completed premilking is detected by the milk transparency rising after an initial fall thereby indicating a peak in the opacity of the milk occurring within a short time from the beginning of the milk flow.

19. An automatic milking apparatus comprising means for premilking a teat from an udder, a teat cup (1) for attachment to the teat after premilking for carrying out a main milking stage in which milk extracted by the teat cup is conducted through a milk line (2) to a container (3), and a transparency sensing means (4) for sensing the transparency of the milk extracted from the teat by the teat cup, characterised in that means (7) are provided for interrupting delivery of milk to the container in response to the milk transparency sensed by the sensing means (4) rising after an initial fall in transparency at the beginning of milk extraction during the main milking stage.

20. An automatic milking apparatus according to claim 19, wherein the means (7) for interrupting delivery of milk to the container is operable to divert milk away from the milk line (2) at least for an initial period from commencement of the main milking stage.

21. An automatic milking apparatus according to claim 19 or 20, wherein the means for interrupting delivery of milk comprises a three-way valve.

22. An automatic milking apparatus according to claim 19, 20 or 21, wherein the transparency sensing means comprises sensor (4) defining a milk flow path and having a light source (5) and a photosensitive component (6) disposed on opposite sides of the milk flow path.

23. An automatic milking apparatus according to claim 22, wherein the light source is a light emitting diode (5) and/or the photosensitive component comprises a phototransistor (6).

24. A method of determining presence of foremilk in a milk flow from a teat of an animal, characterised in that an inverted peak in the transparency of the milk during an initial part of the milk flow is sensed.
